(19) United States
(12) Patent Application Publication
(10) Pub. No.: US 2024/0187070 A1
(43) Pub. Date: Jun. 6, 2024

(54) METHODS OF REPORTING ADDITIONAL DELAYS FOR PORT SELECTION CODEBOOK

(71) Applicant: NTT DOCOMO, INC., Tokyo (JP)

(72) Inventors: Nadisanka Rupasinghe, Sunnyvale, CA (US); Yuki Matsumura, Tokyo (JP)

(73) Assignee: NTT DOCOMO, INC., Tokyo (JP)

(21) Appl. No.: 18/552,342

(22) PCT Filed: Mar. 24, 2022
(86) PCT No.: PCT/US2022/021734

§ 371 Date: Sep. 25, 2023

Related U.S. Application Data
(60) Provisional application No. 63/165,964, filed on Mar. 25, 2021.

(51) Int. Cl. H04B 7/06; H04L 27/26; H04W 72/232

(52) U.S. Cl. CPC H04B 7/0626; H04B 7/0639; H04B 7/0663; H04L 27/265; H04W 72/232

(57) ABSTRACT

A wireless communication method for a terminal is disclosed that includes receiving, via Downlink Control Information (DCI) or higher layer signaling, configuration information; and configuring whether to report additional Discrete Fourier Transform (DFT) bases based on the configuration information. In other aspects, a terminal and a system are also disclosed.

### BACKGROUND

### Technical Field

One or more embodiments disclosed herein relate to methods of enhancing Type II port selection codebook for higher rank transmissions.

### Description of Related Art

New Radio (NR) supports Type II channel state information (CSI) feedback for rank 1 and rank 2 (Release 15 of NR).

One or more new working items relating to NR Multiple Input Multiple Output (MIMO) for Release 17 of NR identify requirements for further enhancing a Type II port selection codebook.

For example, with regard to enhancement on CSI measurement and reporting it may be evaluated and, if needed, specify CSI reporting for DL multi-TRP and/or multi-panel transmission to enable more dynamic channel/interference hypotheses for NCJT, targeting both FR1 and FR2.

Further, it may be evaluated and, if needed, specify Type II port selection codebook enhancement (based on Rel. 15/16 Type II port selection) where information related to angle(s) and delay(s) are estimated at the gNode-B (gNB) based on Sounding Reference Signal (SRS) by utilizing downlink (DL)/uplink (UL) reciprocity of angle and delay, and the remaining DL Channel State Information (CSI) is reported by the user equipment (UE), mainly targeting Frequency Division Duplexing (FDD) Frequency Range 1 (FR1) to achieve better trade-off among UE complexity, performance and reporting overhead.

In other words, discussed herein is how the Type II port selection codebook may be further extended by mapping multiple spatial domain (SD)—frequency domain (FD) base pairs to a CSI-RS port for DL beamforming.

### CITATION LIST

### Non-Patent References

[Non-Patent Reference 1] 3GPP RP 193133, “New WID: Further enhancements on MIMO for NR”, Dec., 2019.

[Non-Patent Reference 2] 3GPP RAN1 #104-e, ‘Chairman's Notes’, Feb., 2021.

[Non-Patent Reference 3] 3GPP TS 38.214, “NR; Physical procedure for data (Release 16).”

### SUMMARY

In general, in one aspect, embodiments disclosed herein relate to a wireless communication method for a terminal that includes receiving, via Downlink Control Information (DCI) or higher layer signaling, configuration information; and configuring whether to report additional Discrete Fourier Transform (DFT) bases based on the configuration information.

In general, in one aspect, embodiments disclosed herein relate to a terminal that includes a receiver that receives, via DCI or higher layer signaling, configuration information; and a processor that configures whether to report additional DFT bases based on the configuration information.

In general, in one aspect, embodiments disclosed herein relate to a system that includes a terminal and a base station. The terminal includes: a first receiver that receives, via DCI or higher layer signaling, configuration information; and a processor that configures whether to report additional DFT bases based on the configuration information. The base station includes: a transmitter that transmits via DCI or higher layer signaling, configuration information; and a second receiver that receives the additional DFT reporting.

Advantageously, enhancements on CSI measurement and reporting are being discussed in the development of Release 17 of NR. One of such enhancements includes evaluating and, if needed, specifying CSI reporting for Downlink (DL) multi-Transmission Reception Points (TRP) and/or multi-panel transmission to enable more dynamic channel/interference hypotheses for non-coherent joint transmission (NCJT), targeting both Frequency Range 1 (FR1) (i.e., 410 MHz to 7,125 MHz, sub-6 GHZ) and Frequency Range 2 (FR2) (i.e., 24,250 MHz to 52,600 MHz, mmWaves). Another of such enhancements includes evaluating and, if needed, specifying Type II port selection codebook enhancements (based on Rel. 15/16 Type II port selection) where information related to angle(s) and delay(s) are estimated at a gNB based on Sound Reference Signal (SRS) by utilizing DL/Uplink (UL) reciprocity of angle and delay. The remaining DL CSI is reported by the UE, mainly targeting Frequency Division Duplex (FDD) FR1 to achieve better trade-off among UE complexities, performance, and reporting overhead.

Other embodiments and advantages of the present invention will be recognized from the description and figures.

### BRIEF DESCRIPTION OF THE DRAWINGS

FIG. 1 is a diagram showing a schematic configuration of a wireless communications system according to embodiments.

FIG. 2 is a diagram showing a schematic configuration of a base station (BS) according to one or more embodiments.

FIG. 3 is a schematic configuration of a user equipment (UE) according to one or more embodiments.

FIG. 4 shows an example of K ports CSI-RS transmission and an accompanying example frequency response.

FIGS. 5A and 5B shows an example 4-taps channel analysis.

FIG. 6 shows an example precoder selection based on DFT reporting.

FIG. 7 shows an example of a higher layer parameter.

FIG. 8 shows an example table of DCI code points of the CSI request field.

FIG. 9 shows an example table of DCI code points of the CSI request field.

FIG. 10 shows an example selection of reporting configuration based on whether DFT reporting is configured.

FIG. 11 shows example tables of amplitude quantization.

FIG. 12 shows an example table of codebook parameter configurations.

FIG. 13 shows an example table of codebook parameter configurations.

### DETAILED DESCRIPTION

Embodiments of the present invention will be described in detail below with reference to the drawings. Like elements in the various figures are denoted by like reference numerals for consistency.

In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

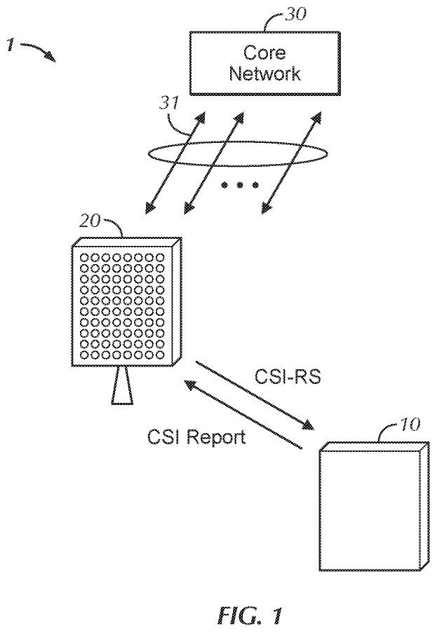

FIG. 1 describes a wireless communications system 1 according to one or more embodiments of the present invention. The wireless communication system 1 includes a user equipment (UE) 10, a base station (BS) 20, and a core network 30. The wireless communication system 1 may be a NR system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB). The BS 20 may be referred to as a network (NW) 20.

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

As shown in FIG. 1, the BS 20 may transmit a CSI-Reference Signal (CSI-RS) to the UE 10. In response, the UE 10 may transmit a CSI report to the BS 20. Similarly, the UE 10 may transmit SRS to the BS 20.

### Configuration of BS

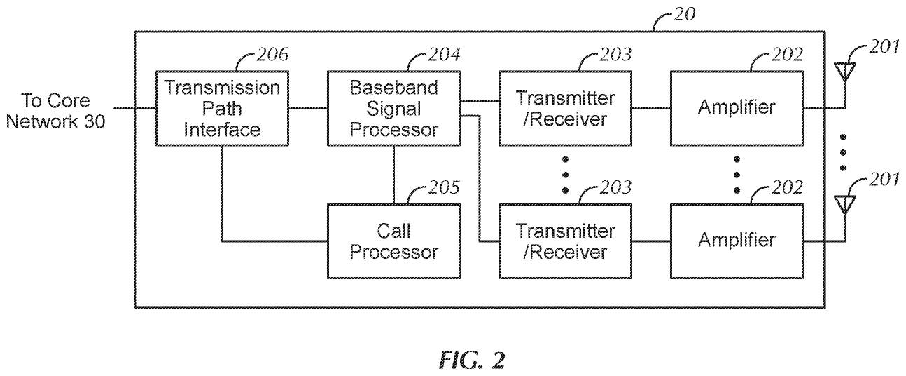

The BS 20 according to embodiments of the present invention will be described below with reference to FIG. 2. FIG. 2 is a diagram illustrating a schematic configuration of the BS 20 according to embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network through the transmission path interface 206. The call processor 205 performs call processing such as setting up and releasing a communication channel, manages the state of the BS 20, and manages the radio resources.

### Configuration of UE

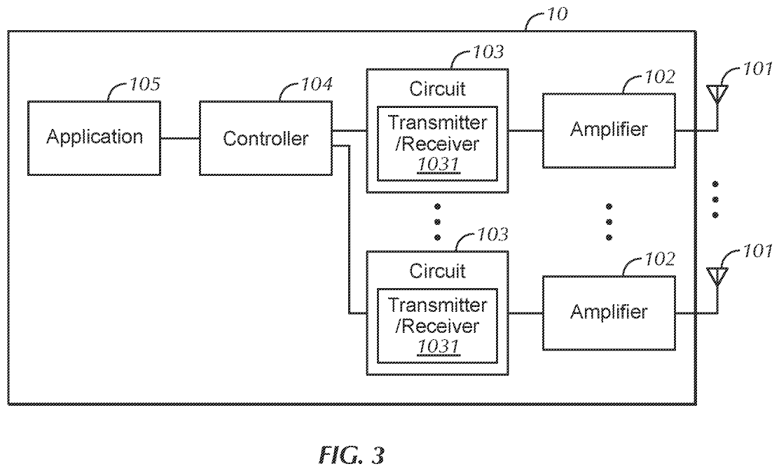

The UE 10 according to embodiments of the present invention will be described below with reference to FIG. 3. FIG. 3 is a schematic configuration of the UE 10 according to embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention relate to port selection (PS) codebook enhancements utilizating DL/UL reciprocity of angle and/or delay. Further, one or more embodiments support codebook structure W=W₁W₂W_{f}^{H} where:
W₁ is a free selection matrix, with an identity matrix as a special configuration and under consideration is potential polarization-common/specific selection; and
W_{f} is a DFT based compression matrix in which N3=N_{CQISubband}*R and Mᵥ>=1.

In this regard, at least one value of Mᵥ>1 is supported. Also under consideration is the potential value(s) of Mᵥ, such as for example, Mᵥ=2.

Consider that support of Mᵥ>1 could be a UE optional feature if the UE supports Rel-17 PS codebook enhancement, which may take into account UE complexity related to codebook parameters. Also consider potential candidate value(s) of R, a mechanism for configuring/indicating to the UE and/or a mechanism for selecting/reporting by UE for W_{f}.

W_{f} can be turned off by gNB. When turned off, W_{f} is an all-one vector; however, also consider the length of an all-one vector when turned off. Additionally, consider other potential signaling/CSI reporting mechanism that may trade-off signaling overhead, UE complexity, and UPT gain.

Further note that the associated codebook configurations and CSI reporting can be different based on whether W_{f} is turned on/off.

With respect to Type II Port Selection Codebook Structure for 5G NR Rel. 17, the port selection codebook for l-th layer can be given as follows in equation (1):

Wₗ(K×N₃)=W_{1,l}\tilde{W}ₗW_{f,l}^{H}

In the above equation (1), the parameters may be given as follows:
W₁ (K×2L): Block diagonal matrix where each matrix block consisting of L columns of an (K×K) identity matrix;
W_{f,l} (N₃×Mᵥ): A matrix consisting of Mᵥ basis vectors from a (N₃×N₃) DFT matrix; and
\tilde{W}ₗ (2L×Mᵥ): Linear combination coefficient matrix.

Note that the gNB can turn off W_{f,l}.

Further, the gNB transmits K beamformed CSI-RS ports. Note that each CSI-RS port is beamformed with a spatial domain (SD) beam and a frequency domain (FD) basis vector. That is, each port is associated with a SD-FD pair. Subsequently, the UE selects L ports out of K and reports them to the gNB as part of PMI (W_{1,l}). Further, the UE reports linear combination (LC) coefficients captured within \tilde{W}ₗ as part of PMI, as well.

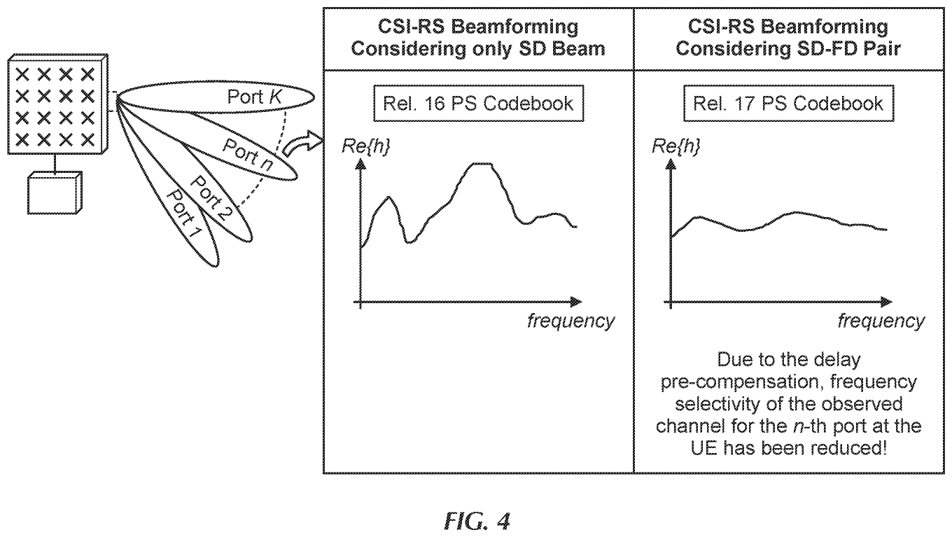

Turning now to capture the physical meaning of the CSI-RS beamforming considering a SD-FD pair, frequency response characterization are discussed. For example, with reference to FIG. 4, assume K ports CSI-RS transmission. Then, the frequency response of the observed channel at the UE associated with n-th port can be represented as shown in FIG. 4. If W_{f,l} is not turned off, the UE can report additional DFTs to further suppress the frequency selectivity of the delay pre-compensated channel.

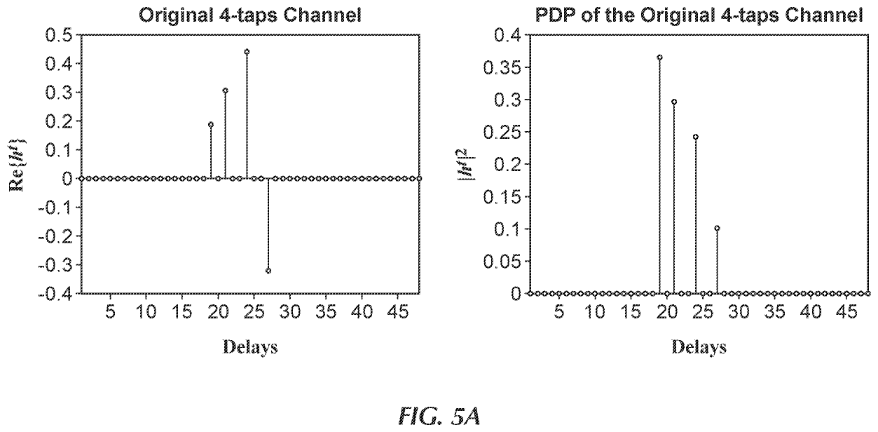

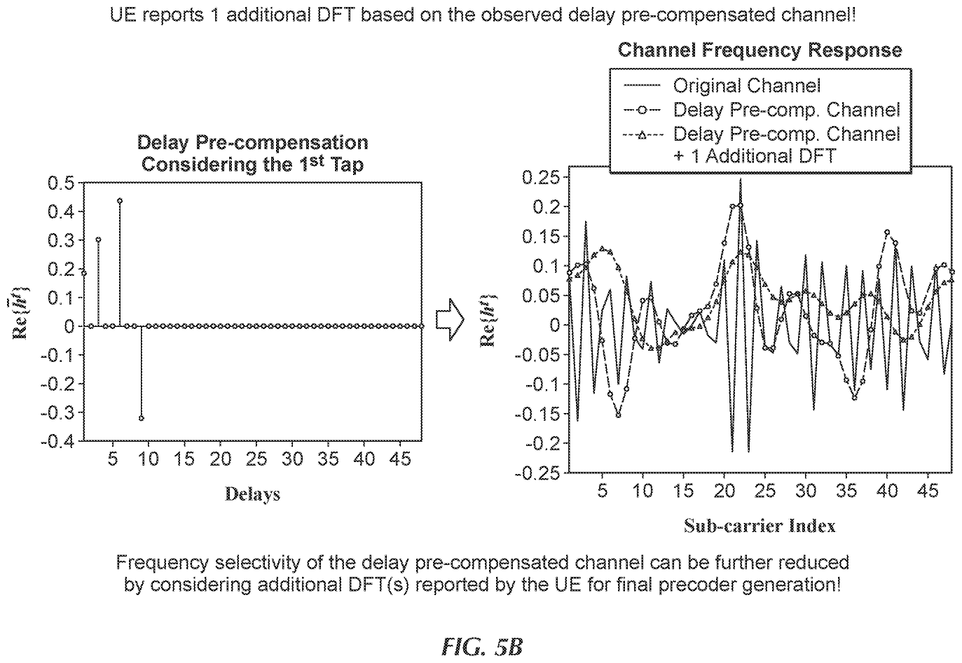

Turning to simulation analysis, channel frequency response is analyzed with additional delays reported by the UE. For example, with reference to FIGS. 5A and 5B, a 4-taps channel is considered. In this example, the UE reports one additional DFT based on the observed delay pre-compensate channel. Frequency selectivity of the delay pre-compensated channel can be further reduced by considering additional DFT(s) reported by the UE for final precoder generation.

One or more embodiments relating to Type II port selection codebook structure for 5G NR Rel. 17 depend on whether the UE is configured to report additional DFTs (hence the presence of W_{f,l} in equation (1)). In particular, one of the two precoders shown in FIG. 6 will be selected. That is, FIG. 6 shows a decision diagram for precoders as to whether additional DFT reporting is configured. It is noted that it may be assumed that the considered SD-FD pairs for beamforming are, {b₁, f₁}, {b₂, f₂}, . . . {b_{K}, fK} and indices of selected SD and FD bases are, s(1), s(2) . . . s(L).

In the equations shown in FIG. 6, the following may be defined:
b̅ₛ₍ᵢ₎: is a column vector from a (K×K) identity matrix. In particular, this vector selects SD-FD bases with index, s(i);
\tilde{f}ₛ₍ⱼ₎: is a column vector from a (N₃×N₃) DFT matrix and s(j) represents index of the selected additional j-th DFT basis; and
c_{i,j}, cᵢ: are LC coefficients.

Also note that the CSI reporting overhead associated with additional DFT reporting can be higher compared to that of not reporting additional DFTs. Further, note that the precoder selection is based on the perspective of the UE.

Those skilled in the art will appreciate that additional DFT reporting may associate with potential advantages or disadvantages. When additional DFT reporting is configured, frequency selectivity of the observed channel at the UE can be further suppressed. Hence, better performance can be expected. On the other hand, CSI reporting overhead can be higher compared to not reporting additional DFTs. With respect to when additional DFT reporting is not configured, CSI reporting overhead can be smaller compared to reporting additional DFTs. On the other hand, performance may be degraded due to the lack of knowledge of the channel observed by the UE in the DL.

As discussed above, studies are under way with regard to Type II port selection codebook structure. In one or more embodiments described herein, consider the configuration of reporting additional DFT bases within W_{f,l}. At the outset, a UE can be configured to report additional DFT bases while considering the following potential options.

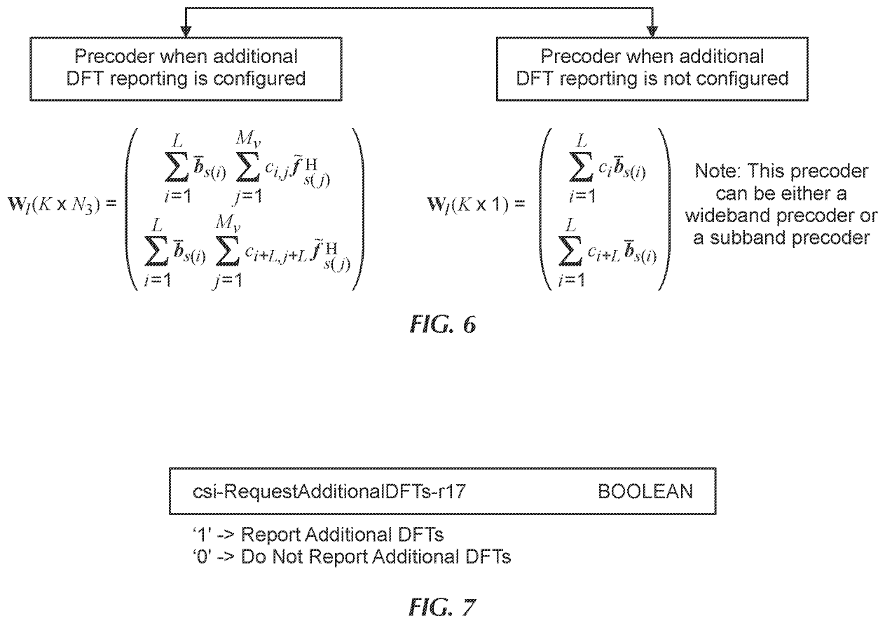

As a first option, using higher-layer signaling, the UE can be configured to report additional DFT bases. For example, consider the new RRC parameter described in FIG. 7. That is, with a potential new RRC parameter the UE can be configured as to whether or not to report additional DFTs. Note here that this can implicitly be configured by configuring/not configuring, β and pᵥ as discussed further below.

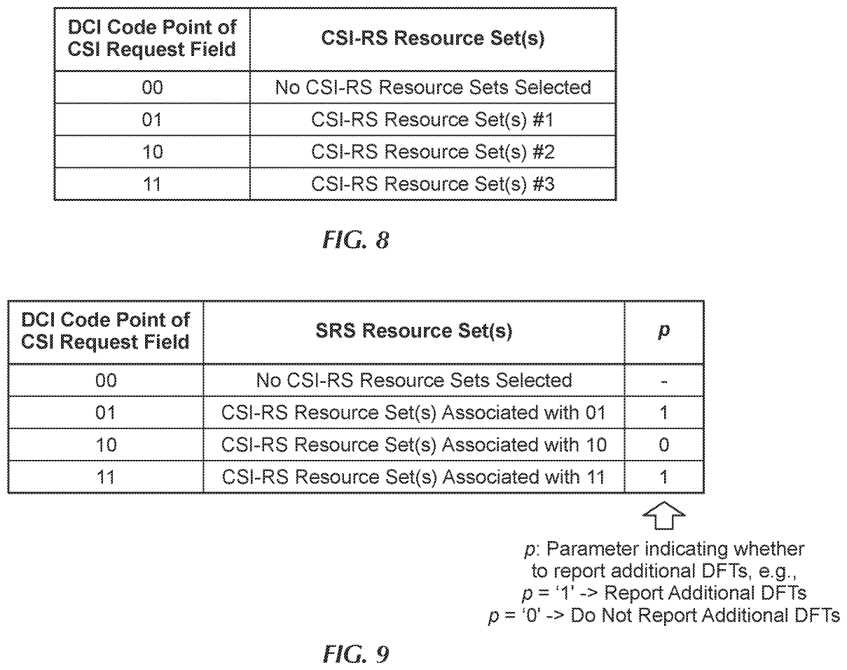

As a second option, using DCI, the NW can dynamically switch between whether to report/not report additional DFT bases. For example, an additional DCI field (of size 1-bit) can be added to explicitly switch between reporting/not reporting additional DFTs. As another example, DCI can implicitly indicate whether to report/not report additional DFTs. Additionally, as an example consider that whether to report/not report additional DFT bases may be configured using RRC signaling per each Aperiodic CSI triggering state. Subsequently, using the existing DCI field for a CSI triggering state, whether to report/not report additional DFTs can be indicated. For example, a DCI code point of the CSI request field may indicate an appropriate CSI-RS resource implicitly by indicating whether additional DFT reporting is required. An example is captured in FIG. 8. Note here that each CSI-RS resource set is configured with whether to report/not report additional DFTs.

As another example, consider that whether to report/not report additional DFTs may be implicitly configured by associating it with the DCI code point of the CSI request field of triggering DCI. An example is captured in FIG. 9. Note that the mapping between the DCI codepoint of the CSI request field and the parameter p is higher-layer configured. Here, p is a parameter indicating whether to report additional DFTs. For example,
p=‘1’→report additional DFTs; and
p=‘0’→do not report additional DFTs.

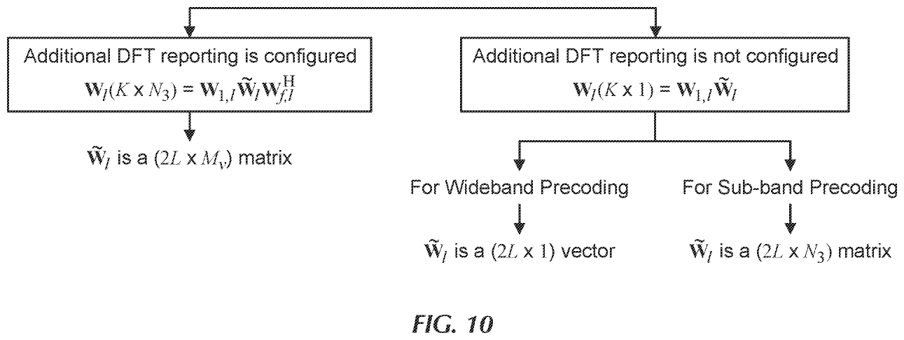

In one or more embodiments configuration of reporting \tilde{W}ₗ is considered. At the outset, it is noted that the structure of \tilde{W}ₗ can be different based on whether the UE is configured to report additional DFTs. For example, a summary of possible structures is captured in FIG. 10. That is, FIG. 10 shows an example of selecting whether or not additional DFT reporting is configured and additionally whether wideband precoding or sub-band precoding is configured. Consider that for each case, the necessary information the UE needs to report to the gNB may differ.

In one or more embodiments, when additional DFT reporting is configured, \tilde{W}ₗ is a (2L×Mᵥ) matrix. In addition, as a first option a bitmap whose non-zero bits identify which coefficients within \tilde{W}ₗ are reported by the UE, is also reported as part of PMI. For example, the following rule for the bitmap can be considered (Note that, the bitmap size is the same as \tilde{W}ₗ):
‘1’→LC coefficient associated with the position of \tilde{W}ₗ is reported by the UE
‘0’→LC coefficient associated with the position of \tilde{W}ₗ is not reported by the UE

Note here that the UE can consider a compression scheme such as combinatorial signaling or Huffman encoding to further reduce the size of bitmap.

As a second option, all of the LC coefficients within \tilde{W}ₗ may be reported as part of PMI (i.e., no bitmap reporting). In this case, all of the LC coefficients within \tilde{W}ₗ are reported without any selection. It is noted that the associated overhead in this case can be larger compared to the case where the bitmap is reported. Further, the UE does not expect β parameter, e.g., as shown in Table 5.2.2.2.6-1 [3], to be configured when no bitmap reporting.

Note here that as per [3], in Rel. 16 Type II PS codebook the maximum number of non-zero LC coefficients reported per layer is K₀=[β2LM₁]. Here, L is the number of selected ports and M₁ is the number of DFT bases reported for layer 1. β(<1) is higher-layer configured, i.e., by Table 5.2.2.2.6-1 [3], to limit the number of reported non-zero LC coefficients. The bitmap is used for indicating what LC coefficients are reported from \tilde{W}ₗ. However, when there is no bitmap reporting, the UE should report all of the LC coefficients. Hence, there is no need of configuring β. Further, even if β is configured, the UE may ignore it.

As another example, consider that using higher-layer signaling or DCI, the UE may be configured whether to report a bitmap. For example, if configured consider the bitmap reporting as in the first option above and if not configured consider the lack of bitmap reporting as in the second option above.

As a third option, consider when additional DFT reporting is not configured. That is, for wideband precoding, \tilde{W}ₗ is a (2L×1) vector. In this instance, the UE does not expect β and pᵥ/Mᵥ parameters, e.g., in Table 5.2.2.2.6-1 [3], to be configured. Further, in this instance the UE does not need to report a bitmap.

As a fourth option, consider when additional DFT reporting is not configured. That is, for sub-band precoding, \tilde{W}ₗ is a (2L×N₃) matrix. In this instance, the UE does not expect β and pᵥ parameters, e.g., in Table 5.2.2.2.6-1 [3], to be configured. Further, in this instance the UE does not need to report a bitmap.

As a fifth option, consider that by using higher-layer signaling or DCI, the UE is configured whether to consider wideband precoding or sub-band precoding when determining and reporting \tilde{W}ₗ. In this scenario, if configured then consider \tilde{W}ₗ determining/reporting as in the third option (wideband reporting) and if not configured then consider \tilde{W}ₗ determining/reporting as in the fourth option (subband reporting).

Additionally, it is possible to consider different amplitude and phase quantization for the wideband precoding case and the sub-band precoding case as discussed further below. A bitmap here in the above discussion is a matrix whose non-zero bits identify which coefficients within \tilde{W}ₗ are reported by the UE. This is also reported as part of PMI.

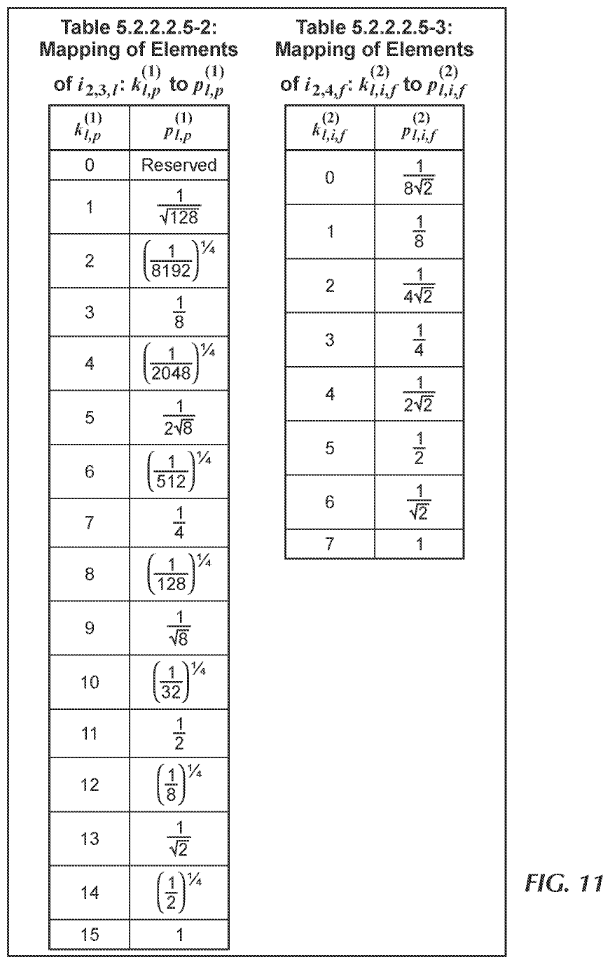

As a sixth option, consider that different quantization schemes can be considered for LC coefficients quantization based on whether additional DFT reporting is configured or not. For example, when additional DFT reporting is configured, amplitudes and phases of LC coefficients within W can be quantized as follows. For amplitude quantization, consider 16-level amplitude quantization as shown in FIG. 11 in Table 5.2.2.2.5-2 [3]. Also consider 8-level amplitude quantization as in FIG. 11 in Tables 5.2.2.2.5-2 or 5.2.2.2.5-3 [3]. Those skilled in the art will also appreciate consideration of the possibility of higher-level amplitude quantization, e.g, 32-level.

For phase quantization, consider 8-psk for phase quantization, e.g.,

$${φ}_{l , i} = {e}^{j \frac{2 π {c}_{l , i}}{8}} , {c}_{l , i} ∈ \{ 0 , … , 7 \}$$

where c_{l,i} is the phase coefficient reported by the UE (i.e., using 3-bits) for associated phase value φ_{l,i}. Additionally, consider 16-psk for phase quantization, e.g.,

$${φ}_{l , i} = {e}^{j \frac{2 π {c}_{l , i}}{16}} , {c}_{l , i} ∈ \{ 0 , … , 15 \}$$

where c_{l,i} is the phase coefficient reported by the UE (i.e., using 4-bits) for associated phase value φ_{l,i}. Further, consider 32-psk for phase quantization, e.g.,

$${φ}_{l , i} = {e}^{j \frac{2 π {c}_{l , i}}{32}} , {c}_{l , i} ∈ \{ 0 , … , 31 \}$$

where c_{l,i} is the phase coefficient reported by the UE (i.e., using 5-bits) for associated phase value φ_{l,i}. Those skilled in the art will appreciate that other amplitude and phase quantization schemes are not precluded.

As seventh option, consider that when additional DFT reporting is not configured, the same amplitudes and phases of LC coefficients quantization within \tilde{W}ₗ in the sixth option may be utilized. Note here that higher amplitude and phase resolutions can be considered for the wideband precoding case.

As an eighth option, consider that by using higher-layer signaling or DCI, the UE can be configured with what quantization scheme to consider for amplitude and phase quantization, which may be applicable to both the sixth and seventh options.

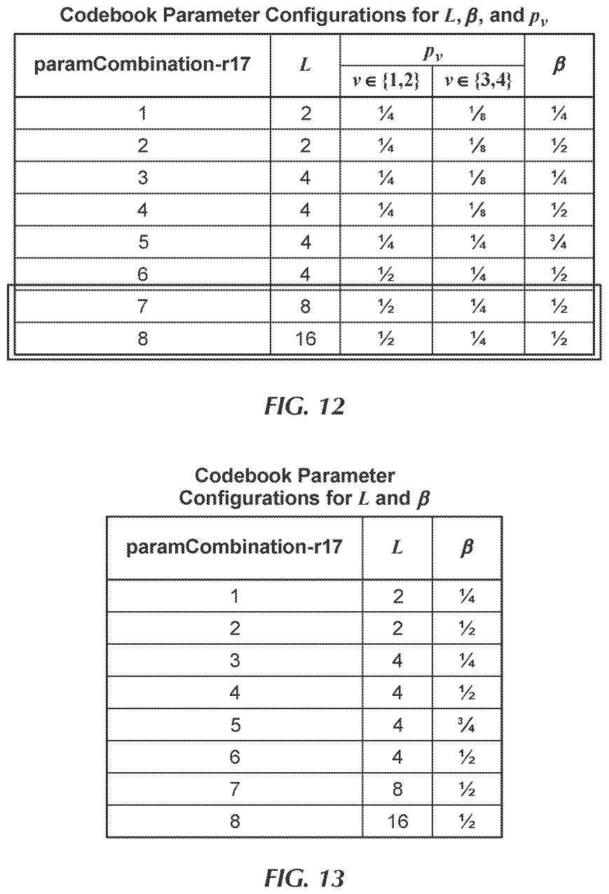

In one or more embodiments, parameter combinations for a Rel. 17 port selection codebook are considered. For example, when additional DFT reporting is configured, the values of L, β, and ᵥ are determined by the higher layer parameter paramCombination-r17, e.g., the mapping between a given value for paramCombination-r17 and L, βand pᵥ can be captured in the specification(s) as given in the table shown in FIG. 12. Note that the content of Table 5.2.2.2.6-1 from Rel. 16 may be updated in Rel. 17. For example, rows 7 and 8 in FIG. 12 are added in comparison to Table 5.2.2.2.6-1 of [3].

As a first option, consider that pᵥ, Mᵥ can be calculated as follows [3]:

$${M}_{υ} = ⌈ {p}_{υ} \frac{{N}_{3}}{R} ⌉$$

As a second option, consider that it is also possible that, pᵥ=Mᵥ for some or all of the parameter combinations configured using, paramCombination-r17.

In addition to currently available L values, new parameter combinations can be defined considering L=6, 8, 10, 12, 14, 16, 20, 24. It is further noted that those skilled in the art will appreciate that other values are not precluded.

In one or more embodiments, consider that when additional DFT reporting is configured, the values of L and β are determined by the higher layer parameter paramCombination-r17, e.g., the mapping between a given value for paramCombination-r17 and L and β can be captured in the specification(s) as given in the table shown in FIG. 13.

In addition to currently available L values, new parameter combinations can be defined considering L=6, 8, 10, 12, 14, 16, 20, 24. It is further noted that those skilled in the art will appreciate that other values are not precluded.

As another example, My can be configured using higher-layer signaling or DCI. For example, there may be multiple values defined in the specification(s) for Mᵥ. Using higher-layer signaling or DCI, one value out of those is selected, e.g., Mᵥ∈{1, 2}. Then using 1-bit in the DCI, one value is selected. As yet another example, a list of values may be configured for Mᵥ using higher-layer signaling. Then, using DCI, one value out of those is selected, e.g., Mᵥ∈{1, 2}. Then using 1-bit in the DCI, one value is selected. Additionally, as another example, Mᵥ may be pre-defined in the specification(s), e.g., Mᵥ=2, is pre-defined in the specification(s).

Note also that those skilled in the art will appreciate that it is also possible to consider one or more of the above embodiments, examples, and options, for codebook parameter configurations when additional DFT reporting is not configured.

In one or more embodiments, consider that when additional DFT reporting is not configured, the UE does not expect β and pᵥ parameters, e.g., in Table 5.2.2.2.6-1 [3], are to be configured. That is, configuring only L may be sufficient. As an option, the value of L may be configured using higher layer signaling, e.g., L={6, 8, 10, 12, 14, 16, 20, 24}. As another option, a list of values for L is configured using higher layer signaling and one value out of those is selected using DCI, e.g., L∈{6, 8, 10, 12} that is configured using higher-layer signaling and using 2-bits in DCI one value out of those is selected. As yet another example, L is pre-defined in the specification(s), e.g., L=16.

It is noted that in the case if β and Mᵥ/pᵥ are configured with additional DFT reporting not configured, then the UE may ignore β and Mᵥ/pᵥ values.

### Variations

The information, signals, and/or others described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/present embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” as used in this specification are used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably.

A mobile station may be referred to as, by a person skilled in the art, a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/present embodiment of the present disclosure may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations may have the functions of the user terminals described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

One or more embodiments illustrated in this specification may be used individually or in combinations, which may be switched depending on the mode of implementation. The order of processes, sequences, flowcharts, and so on that have been used to describe the aspects/present embodiments herein may be re-ordered as long as inconsistencies do not arise. For example, although various methods have been illustrated in this specification with various components of steps in exemplary orders, the specific orders that are illustrated herein are by no means limiting.

One or more embodiments illustrated in the present disclosure may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, assuming, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions, (both visible and invisible) optical regions, or the like.

In this specification, the phrase “A and B are different” may mean that “A and B are different from each other.” The terms “separate,” “be coupled” and so on may be interpreted similarly.

Furthermore, the term “or” as used in this specification or in claims is intended to be not an exclusive disjunction.

Now, although the present invention has been described in detail above, it should be obvious to a person skilled in the art that the present invention is by no means limited to the embodiments described in this specification. The present invention can be implemented with various corrections and in various modifications, without departing from the spirit and scope of the invention defined by the recitations of claims. Consequently, the description in this specification is provided only for the purpose of explaining examples, and should by no means be construed to limit the invention according to the present invention in any way.

### ALTERNATIVE EXAMPLES

The above examples and modified examples may be combined with each other, and various features of these examples may be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A wireless communication method for a terminal comprising:
receiving, via Downlink Control Information (DCI) or higher layer signaling, configuration information; and
configuring whether to report additional Discrete Fourier Transform (DFT) bases based on the configuration information.

2. The wireless communication method of claim 1, wherein when higher layer signaling is used, whether to report additional DFT bases is configured based on a Radio Resource Control (RRC) parameter.

3. The wireless communication method of claim 1, wherein when DCI is used, the terminal dynamically switches between whether to report or to not report additional DFT bases by using an additional DCI field.

4. The wireless communication method of claim 3, wherein whether to report additional DFT bases is configured using RRC signaling per each of Aperiodic Channel State Information (CSI) triggering states.

5. The wireless communication method of claim 4, wherein a DCI code point of a CSI request field indicates an appropriate Channel State Information Reference Signal (CSI-RS) resource that indicates whether to report additional DFT bases.

6. The wireless communication method of claim 1, wherein when additional DFT reporting is configured, a linear combination coefficient matrix is also configured.

7. The wireless communication method of claim 6, wherein non-zero linear combination coefficients in the matrix are reported by the terminal.

8. The wireless communication method of claim 6, wherein all linear combination coefficients in the matrix are reported as part of a Precoding Matrix Indicator (PMI).

9. The wireless communication method of claim 6, wherein the terminal is configured to report a bitmap.

10. The wireless communication method of claim 1, wherein when additional DFT reporting is not configured for wideband precoding and for subband precoding, the terminal does not need to report a bitmap.

11. The wireless communication method of claim 10, wherein the terminal is configured to determine whether wideband precoding or subband precoding is used.

12. The wireless communication method of claim 1, wherein different quantization schemes are considered for linear combinations quantization based on whether additional DFT reporting is configured.

13. The wireless communication method of claim 1, wherein when additional DFT reporting is configured, a plurality of values are determined by a higher layer parameter.

14. A terminal comprising:
a receiver that receives, via Downlink Control Information (DCI) or higher layer signaling, configuration information; and
a processor that configures whether to report additional Discrete Fourier Transform (DFT) bases based on the configuration information.

15. A system comprising:
a terminal comprising:
a first receiver that receives, via Downlink Control Information (DCI) or higher layer signaling, configuration information; and
a processor that configures whether to report additional Discrete Fourier Transform (DFT) bases based on the configuration information; and
a base station comprising:
a transmitter that transmits via DCI or higher layer signaling, configuration information; and
a second receiver that receives the additional DFT reporting.
